(19) United States
(12) Patent Application Publication
(10) Pub. No.: US 2005/0130709 A1
(43) Pub. Date: Jun. 16, 2005

(54) Method and apparatus for providing a clandestine mode of operation

(76) Inventor: Robert P. Muszkiewicz, Scottsdale, AZ (US)

Correspondence Address: Larry G. Brown;Motorola, Inc., Law Department, 8000 West Sunrise Boulevard, Fort Lauderdale, FL, 33322, US

(21) Appl. No.: 10/737,063

(22) Filed: Dec. 16, 2003

(51) Int. Cl. H04M 1/00

(52) U.S. Cl. 455/566

(57) ABSTRACT

A radio communication device includes a surveillance mode key (220) which when activated causes the radio communication device to enter a surveillance or clandestine mode of operation. In this mode, the radio communication device's volume setting is adjusted to a very low level or muted and its display (216) is switched to a red night light backlight (224). Optionally, other lights on the radio can also be switched to red night lights which minimize the chance of the radio being detected. A method for entering the surveillance mode includes the steps of determining if the surveillance mode is desired, and if so, automatically adjusting the lights and sounds of the radio to their predetermined surveillance mode settings.

### TECHNICAL FIELD

This invention relates in general to the field of radio communications and in particular to a method and apparatus for providing a clandestine mode of operation for a radio communication device.

### BACKGROUND

Police officers, military personnel and others who on occasion conduct clandestine or secret operations need to go undetected when conducting these secret operations. At the same time, these individuals typically require the use of a radio communication device so that they can communicate with other team members or support personnel.

Currently, if a police officer wants to conduct a secret or undercover operation, the police officer may need to turn off his or her cellular telephone and/or two-way radio or at least lower the volume setting on the unit so that his undercover operation is not compromised. The police officer may also have to conceal his radio communication device if it has a display or lights that may turn on since that may compromise an undercover operation conducted at night. The process of lowering the volume setting and/or deactivating lights on the radio communication device, if at all possible, may require numerous steps to accomplish, with an equal number of steps required to reset the original settings in the radio communication device once the secret operation has been completed.

Even if a radio communication device's display and/or lights can be disabled, not being able to view the radio communication device's display may cause the radio communication device user to miss out on important information that may have been transmitted to the user. Given this, a need exists in the art for a method and apparatus for providing a clandestine mode of operation in a radio communication device that can minimize some of the problems previously mentioned.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a flowchart of a method of providing a clandestine mode of operation in accordance with one embodiment of the invention.

FIG. 2 shows a block diagram of a radio communication device in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

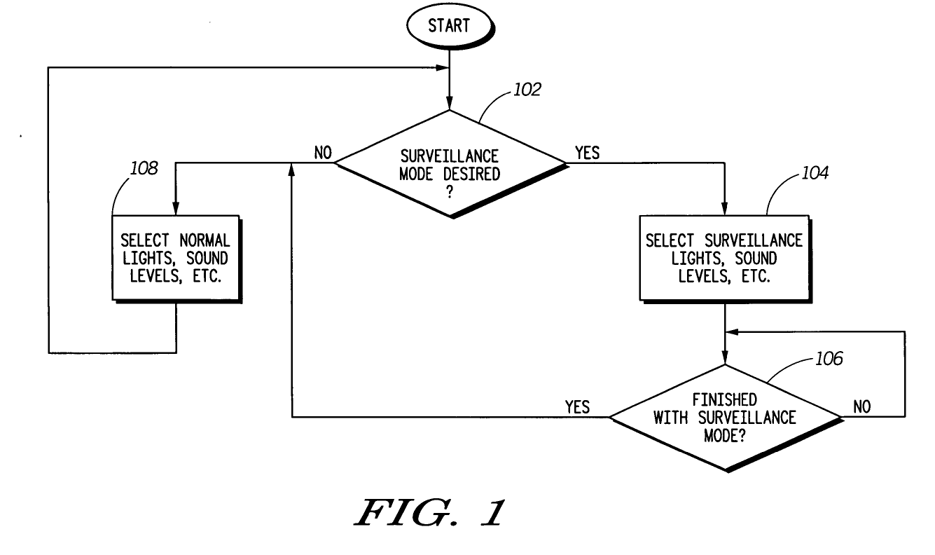

Referring now to FIG. 1, there is shown a flowchart of a method for providing a clandestine operation (surveillance) mode for a radio communication device. In step 102, the radio communication device first determines if the radio user wants to place the radio communication device in a surveillance (clandestine) mode of operation. The surveillance mode of operation is a mode in which the radio user wants to minimize his/her chances of being detected by others. In an embodiment of the invention, the radio communication device has a key or button that when pressed sends a signal to the radio communication device that places the device in a surveillance mode of operation. Alternatively, the surveillance mode can be entered by selecting the mode via a menu found in the radio communication device using the device's keypad and display.

If it is determined in step 104 that the radio user has requested that the radio communication device be placed in the surveillance mode, the radio communication device automatically adjusts its speaker volume level to a predetermined level (e.g., very low volume setting or to a mute setting) and can also switch the lights used by the radio's display from the normal display backlights to red night lights that emit a light that is not easily detected by others at night. Placing the radio communication device in the surveillance mode may also cause other changes to the radio operation, for example, light emitting diodes (LED)'s that may normally light up when the radio communication device is transmitting, or receiving a message (as well as the display backlights), may be disabled, or alternatively, a red light is used instead to signal a message being received, etc. Alerts for incoming calls, messages, etc. in the surveillance mode can be switched to a low level red night light LED or icon flashing in the radio communication device's display.

In one embodiment of the invention, a special surveillance mode button or key located on the radio communication device when activated causes the radio 10 communication device to be placed in the surveillance mode of operation causing some or all of the previously mentioned changes to be made to the radio communication device instantly. A single radio operator action (activating the surveillance mode button or key) can therefore quickly select a clandestine surveillance mode of operation that automatically reconfigures the radio communication device. This provides for a quick way for a police officer or other personnel to get his/her radio communication device ready for a secret operation. The use of red lights on the display and as substitutes for the radio communication device's other lights (e.g., transmit LED) provide for improved secret operation capability.

In step 106, it is determined if the radio communication user wants to finish with the surveillance mode of operation, if the radio user has finished operating in the surveillance mode, the user can depress the surveillance mode button or key again and the routine moves to step 108, whereby the normal backlights, sound levels, etc. are restored for normal operation.

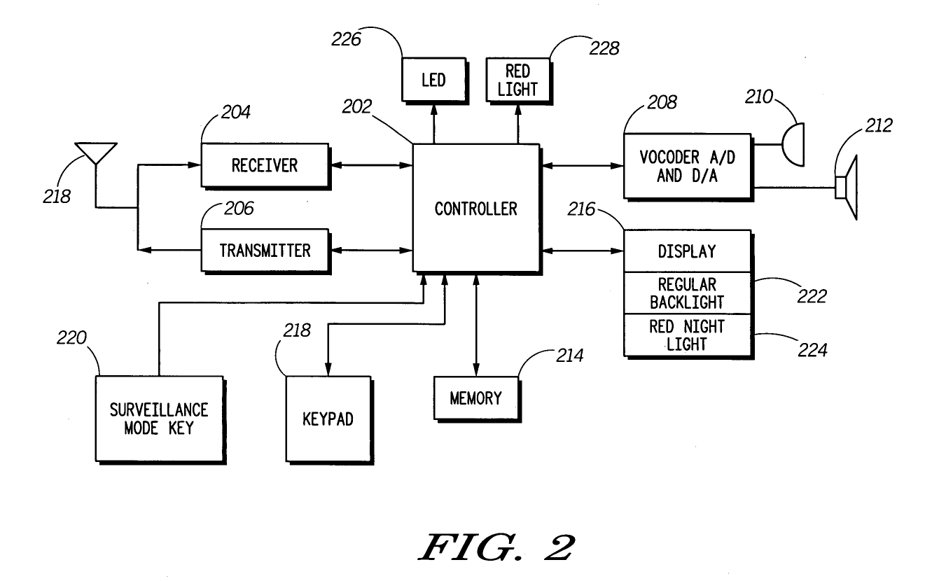

Referring now to FIG. 2, there is shown a block diagram of a radio communication device such as a two-way radio or cellular telephone. The radio communication device includes a conventional receiver 204 and transmitter 206 selectively coupled to an antenna 218. A controller 202 such as a microprocessor and/or digital signal processor controls the overall function and operation of the communication device. User controls such as a keypad 218 and display 216 are coupled to the controller 202 and allow for user interface with the communication device. The display 216 includes the ability to select between a first or regular backlight 222 emitting an easily detectable white light and a red night backlight 224 which provides less chance of being detected by others at night.

Memory 214 can comprise both volatile and nonvolatile memory including but not limited to Random Access Memory (RAM), flash memory, Read-Only Memory (ROM), etc. Memory 214 also stores the necessary instructions and information for controller 202. Located in memory 214 are all the instructions necessary to perform the surveillance mode switching of the present invention.

A microphone 210 is provided for converting voice from the user into electrical signals, while a speaker 212 provides audio signals to the user. A vocoder, Analog-to-Digital (A/D) and Digital-to-Analog (D/A) block 208 provides all the necessary digital voice processing for converting analog voice into digital information ready for RF transmission and vice versa.

A surveillance mode key 220 which can be a separate key located on the radio communication device housing or alternatively either one assigned key in keypad 218 or a menu item selected by the radio user via keypad 218, when activated, causes the radio communication device to enter the surveillance mode. In this mode, the audio block 208 adjusts the speaker volume to a very low level or mutes it completely depending on how the volume level has been programmed. Also, the controller 202 informs the display 216 to switch from the first or standard backlight 222 to the red night backlight 224. The red backlight 222 for display 216 can be automatically adjusted to different light intensity levels or completely disabled when the surveillance mode is selected. In one embodiment, when the surveillance mode is selected, a low level light intensity is set for the red backlight 222 of display 216. In still another embodiment, all of the light emitting sources found on the radio communication device such as LED 226, Red light 228, regular backlight 222 and red night backlight 224 are disabled when the surveillance mode is selected.

Activating the surveillance mode key 220 a second time places the radio communication device back to its normal mode of operation using the previously set volume level and using the regular backlight for the display 216. Instead of using a conventional Light Emitting Diode (LED) 226 to signal that an incoming message has been received or that the radio communication device is transmitting, the LED 226 is disabled and a low intensity level red light 228 that is not easily visible to others is selected in its place if the surveillance mode has been selected.

The present invention provides for a quick and easy way to adjust a radio communication so that it can be placed in a clandestine or surveillance mode without the user being required to adjust volume setting, display lighting, etc. By simply activating the surveillance mode key 220 the radio controller 202 makes all the necessary adjustments required to place the radio in its surveillance mode which is very beneficial to radio users such as police officers and military personnel.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for placing a radio communication device having a display that includes a first backlight and a red backlight in a surveillance mode, comprising the steps of:
determining if the surveillance mode has been selected; and
switching the display so that it uses the red backlight instead of the first backlight if the surveillance mode has been selected.

2. A method as defined in claim 1, wherein the radio communication device has a speaker that can be adjusted to different volume levels and the method further comprises the step of:
automatically adjusting the volume level of the speaker to a predetermined level if the surveillance mode has been selected.

3. A method as defined in claim 2, wherein the surveillance mode is selected by activating a key located on the radio communication device.

4. A method as defined in claim 2, wherein the speaker is automatically muted if the surveillance mode is selected.

5. A method as defined in claim 2, wherein if the surveillance mode has been selected any alerts for incoming calls or messages are provided by a red light.

6. A method as defined in claim 2, wherein if the surveillance mode has been selected any alerts for incoming calls or messages are provided by an icon displayed on the display.

7. A method as defined in claim 4, wherein all audible alerts previously provided for incoming calls or messages are muted if the surveillance mode has been selected.

8. A method as defined in claim 1, wherein the radio communication device comprises a two-way radio communication device.

9. A method as defined in claim 1, wherein the radio communication device comprises a cellular telephone.

10. A method as defined in claim 3, wherein once in the surveillance mode, activating the key again causes the radio communication device to automatically switch the display so that the first backlight is used and the volume level of the speaker is returned to the same level it was set at prior to the surveillance mode being entered.

11. A radio communication device, comprising:
a display having a first backlight and a red backlight; and
a surveillance mode key coupled to the display for automatically switching the display to operate using the red backlight instead of the first backlight.

12. A radio communication device as defined in claim 11, wherein the radio communication device comprises a two-way radio.

13. A radio communication device as defined in claim 11, wherein the radio communication device comprises a cellular telephone.

14. A radio communication device as defined in claim 11, further comprising:
a speaker coupled to the surveillance mode key;
an audio block coupled to the speaker; and
activating the surveillance mode key causes the audio block to set the audio volume level of the speaker to a predetermined level.

15. A radio communication device as defined in claim 14, wherein activating the surveillance mode key causes the audio block to mute the speaker.

16. A radio communication device as defined in claim 11, further comprising:
a controller coupled to the surveillance mode key;
a LED coupled to the controller used for alerting when messages are received; and
a red light coupled to the controller, and the controller causes the LED to be deactivated and the red light to be activated and used to alert when messages are received when the surveillance mode key is activated.

17. A method for placing a radio communication device in a surveillance mode, comprising the steps of:
determining if the surveillance mode has been selected; and
adjusting the audio level and one or more light emitting sources found on the radio communication device to predetermined states of operation if the surveillance mode has been selected.

18. A method as defined in claim 17, wherein the surveillance mode is selected by activating a surveillance mode key found in the radio communication device.

19. A method as defined in claim 17, wherein one of the light emitting sources on the radio communication device includes a display having a backlight and when the surveillance mode is selected, the display is backlit with a red light.

20. A method as defined in claim 19, wherein the red light found on the display can be adjusted to different light intensity levels and when the surveillance mode is selected, the red light is adjusted to a low light intensity level.

21. A method as defined in claim 17, wherein one of the one or more light emitting sources comprises a backlight on a display located on the radio communication device and when the surveillance mode is selected, the backlight is turned off.

22. A method as defined in claim 17, wherein the one or more light emitting sources are disabled when the surveillance mode is selected.
